(19) United States
(12) Patent Application Publication
(10) Pub. No.: US 2009/0243828 A1
(43) Pub. Date: Oct. 1, 2009

(54) VEHICLE EMAIL SYSTEM AND METHOD

(75) Inventors: Carl J. Hering, Farmington Hills, MI (US); Christopher L. Oesterling, Troy, MI (US); John J. Correia, Livonia, MI (US)

Correspondence Address: General Motors Corporation;c/o REISING, ETHINGTON, BARNES, KISSELLE, P.C., P.O. BOX 4390, TROY, MI, 48099-4390, US

(73) Assignee: GENERAL MOTORS CORPORATION, Detroit, MI (US)

(21) Appl. No.: 12/059,414

(22) Filed: Mar. 31, 2008

(51) Int. Cl. B60Q 1/00; G01M 17/00

(52) U.S. Cl. 340/439; 701/29

(57) ABSTRACT

A method provides vehicle information to an interested party, such as a vehicle owner or driver, regarding the operation of a vehicle. The method includes the step of measuring a parameter of operation produced by the vehicle. A level based on the parameter measured is then calculated. A notification message that includes information concerning the level is constructed. The method then sends the notification message to the interested party via an electronic messaging system. The electronic messaging system can be an email communication system.

### TECHNICAL FIELD

This invention relates to methods for communicating with those with an interest in a vehicle's operation and, more particularly, the invention relates to techniques for wirelessly collecting vehicle information and providing that information to a party interested in the operation of the vehicle.

### BACKGROUND OF THE INVENTION

Vehicles equipped with communication systems have the capability of communicating between various entities. A vehicle communications system may communicate with a call center, another vehicle, an EMS service, and the like. Systems also allow information, messages and/or instructions to be sent to the owner, operator or driver of the vehicle. These communications may be in the form of light displays on the instrument panel of the vehicle, or calls made to the vehicle. In some instances, a call center may communicate in an alternative method to another location. One example of this type of communication is when the call center sends an email to an email address indicated by the owner of the vehicle as a destination for such communications. These emails may have specific information set forth therein or they may merely provide a link to a website to which the owner of the vehicle is directed. Oftentimes, these email communications relate to issues relating specifically to the vehicle. An owner, or someone designated as the person to receive these communications (hereinafter referred to as “interested party”), may wish to have email communications forwarded that relate to a specific subject relating to the vehicle.

### SUMMARY OF THE INVENTION

According to an aspect of the invention, there is provided a method for providing vehicle information to an interested party regarding the operation of a vehicle. The method includes the step of measuring a parameter of operation produced by the vehicle. A level based on the parameter measured is then calculated. A notification message that includes information concerning the level is constructed. The method then sends the notification message to the interested party via an electronic messaging system.

### BRIEF DESCRIPTION OF THE DRAWINGS

One or more preferred exemplary embodiments of the invention will hereinafter be described in conjunction with the appended drawings, wherein like designations denote like elements, and wherein:

FIG. 1 is a block diagram depicting an exemplary embodiment of a communications system that is capable of utilizing the method disclosed herein; and

FIG. 2 is a logic chart of one embodiment of the inventive method.

### DETAILED DESCRIPTION OF THE PREFERRED EMBODIMENT(S)

The method described below provides a means for an interested party to receive communications via email that are directed toward a specific subject matter relating to some performance of the vehicle. A communications system and method incorporating the notification of information via email to an interested party is disclosed in U.S. Patent Application Publication No. 2007/0173992 A1, which is under ownership common to this patent application and is hereby expressly incorporated by reference. The communications can be periodic or sent after the occurrence of a specific event. In one embodiment, the subject for the operation or performance relates to how much or how little of an impact the operation of the vehicle is having on the environment.

### Communications System

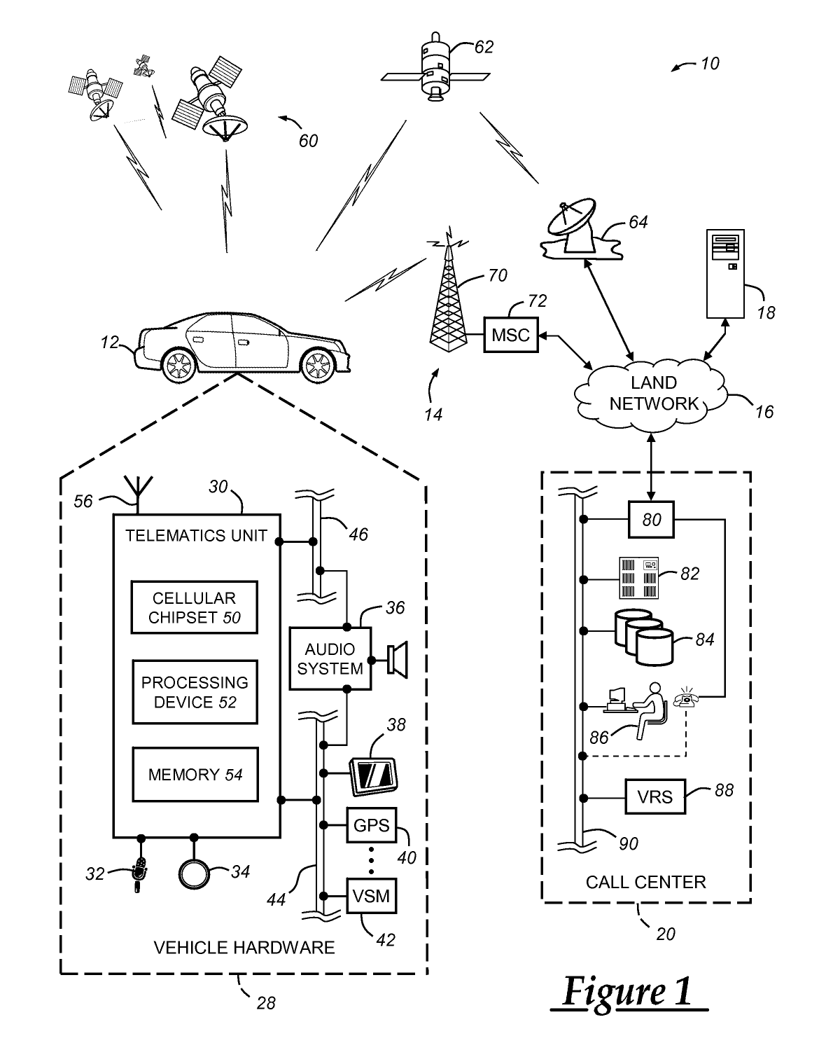

With reference to FIG. 1, there is shown an exemplary operating environment that comprises a mobile vehicle communications system 10 and that can be used to implement the method disclosed herein. Communications system 10 generally includes a vehicle 12, one or more wireless carrier systems 14, a land communications network 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such exemplary system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 is an OEM-installed device that enables wireless voice and/or data communication over wireless carrier system 14 and via wireless networking so that the vehicle can communicate with call center 20, other telematics-enabled vehicles, or some other entity or device. The telematics unit 30 preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM or CDMA standards and thus includes a standard cellular chipset 50 for voice communications like hands-free calling, a wireless modem for data transmission, an electronic processing device 52, one or more digital memory devices 54, and a dual antenna 56. The memory device(s) 54 include a preferred roaming flag 55, which is a dedicated bit in memory that identifies when a preferred roaming list is outdated or whether it is current. It should be appreciated that the modem can either be implemented through software that is stored in the telematics unit and is executed by processor 52, or it can be a separate hardware component located internal or external to telematics unit 30. The modem can operate using any number of different standards or protocols such as EVDO, CDMA, GPRS, and EDGE. Wireless networking between the vehicle and other networked devices can also be carried out using telematics unit 30. For this purpose, telematics unit 30 can be configured to communicate wireless according to one or more wireless protocols, such as any of the IEEE 802.11 protocols, WiMAX, or Bluetooth. When used for packet-switch data communication such as TCP/IP, the telematics unit can be configured with a static IP address or can set up to automatically receive an assigned IP address from another device on the network such as a router or from a network address server.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

### Method

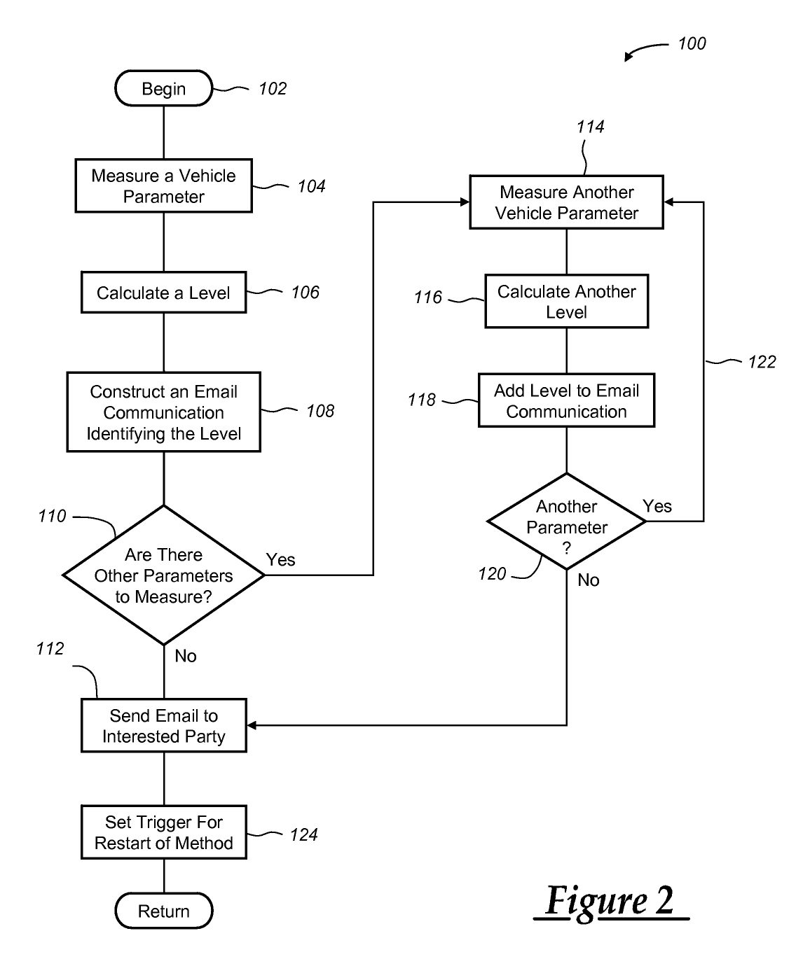

Turning now to FIG. 2, there is a logic chart of a method 100 for providing vehicle information to an interested party. The method begins at 102. The first step 104 includes a measurement of one or more vehicle parameters. The vehicle parameter that is being measured may be any parameter that indicates a function of the vehicle 12. In one embodiment, the vehicle parameters that are being measured include those that related to the consumables of the vehicle 12. In particular, the consumables of a vehicle 12 include tires, fuel and oil. As is well known, the consumption of these three items during the operation of a vehicle 12 has an impact on the environment. There are many owners and operators of vehicles 12 that would find benefit in understanding how their operation of a vehicle 12 relates to the consumption of these items as well as information relating to the reduction of the consumption of the fuel, oil and tires. It should be appreciated by those skilled in the art that any number of items may be added to the list of consumables in that these consumables are identified for purposes of providing examples only.

Once the vehicle parameters are measured, a level is calculated at 106. The level relates to the amount of savings an operator of a vehicle 12 incurs through the operation of that vehicle 12. Examples of how a level is calculated are set forth below.

Once a level is calculated, the method 100 constructs a notification message that includes information concerning the level at 108. The notification message may be an email message, using markup language, or it may simply be a text message. The message is generated at the call center 20 and will be sent over a wireless network similar or identical to the one shown in FIG. 1. The notification message (hereinafter the “email communication”) will also include information regarding the vehicle parameter that was measured. More specifically, the email communication will include information regarding the actual consumption of the consumable (the vehicle parameter measured) and the level that is calculated based on the measurement of the vehicle parameter. The level will indicate information relating to savings created by the operator of the vehicle 12 by the actions taken by those that drive the vehicle 12 between the time that the email communication was constructed and when the previous email communication was constructed. The savings may be described in terms of gallons of fuel saved, barrels of oil saved and the like. In some situations, the savings may be converted into reduction in the amount of carbon dioxide produced.

The method 100 then determines whether there are other parameters that are required to be measured at 110. If not, the method 100 sends the email communication to the interested party at 112. If, however, other parameters need to be measured, the method 100 measures another vehicle parameter at 114. Once the next vehicle parameter is measured, the method 100 calculates a level associated with that particular vehicle parameter at 116. The level and vehicle parameter associated with that measurement are added to the email communication at 118. The method 100 determines whether another parameter is to be measured at 120. If so, the method loops back through loop 122 to measure another vehicle parameter at 114. If not, the method sends the email that has been constructed including all of the vehicle parameters measured and all of the levels calculated at 112. A trigger is set at 124. The trigger determines when the next vehicle parameters are to be measured. The method then returns until the trigger identifies that the method is to begin again.

### Example 1

### Oil Consumption Savings

By way of example only, a table set forth herein shows how the vehicle 12 consumes oil. This table shows that the oil was changed once between the dates of Nov. 25, 2005 and Nov. 20, 2006. The oil change occurred when the detection systems onboard the vehicle 12 identified the near exhaustion of the life of the oil.

| OIL READING | ODOMETER | DATE |
|---|---|---|
| 94.1 | 14491 | Nov. 25, 2005 |
| 79.2 | 17192 | Dec. 26, 2005 |
| 51.3 | 23651 | Jan. 24, 2006 |
| 27.8 | 28821 | Feb. 23, 2006 |
| 19.6 | 30387 | Mar. 7, 2006 |
| 4.7 | 33370 | Mar. 7, 2006 |
| 99.9 | 37686 | Apr. 26, 2006 |
| 96.4 | 38652 | Jun. 6, 2006 |
| 96 | 38660 | Jul. 4, 2006 |
| 94.5 | 39014 | Jul. 23, 2006 |
| 85.4 | 40886 | Aug. 22, 2006 |
| 83.9 | 41113 | Oct. 23, 2006 |
| 61.9 | 46170 | Nov. 20, 2006 |

From this data, the method 100 calculates a baseline of standard oil changes based on a 3,000 mile standard by applying a factor of 1.609, developed from average oil change figures, to the number of oil changes to develop the following formula:

$$( \frac{Current\_ODO - Start\_ODO}{3000 * 1.609} ) = \frac{46170 - 14491}{3000 * 1.609}$$

This translates into 6.6 oil changes. With a five quart oil pan, the amount of oil normally changed is approximately 33 quarts, or 8.25 gallons.

With the new means for measuring oil life, only a single oil change occurred. And at the time the email communication was to be generated, 61.9% of the life of the oil remained for the oil that replaced the first oil. By using the method, the level is generated using the following formula:

No._of_Oil_Changes+(1−Oil_Life_left)=1+(1−0.619)=1.381_Changes

With a 5 quart oil change, this means that 6.9 quarts of oil have been consumed (1.73 gallons). The method will show the difference between the two as a savings of 6.5 gallons of oil. As stated above, this could be translated in barrels saved or in terms of unproduced carbon dioxide. When the level is determined, it can be sent by email communication to the interested party.

### Example 2

### Tire Pressure

Another example relates to tire pressure and the savings associated with maintaining a proper tire pressure in each of the tires. A table set forth herein shows how the vehicle 12 as tire pressure varies.

| | | LF | RF | RR | LR |
|---|---|---|---|---|---|
| DATE | ODOMETER | TIRE | TIRE | TIRE | TIRE |
| Jul. 10, 2007 | 421 | 30 | 30 | 30 | 30 |
| Aug. 10, 2007 | 1500 | 30 | 30 | 30 | 30 |
| Sep. 7, 2007 | 2480 | 30 | 30 | 30 | 30 |
| Oct. 11, 2007 | 3792 | 28 | 28 | 28 | 28 |
| Oct. 27, 2007 | 4228 | 28 | 28 | 28 | 28 |
| Nov. 26, 2007 | 5106 | 26 | 25 | 26 | 26 |

As can be seen the tire pressure measured in the first three instances was correct. The tire pressure did, however, drop to levels that affected fuel consumption in the last three instances. Using a calculation, it can be determined that fuel savings could have amounted to 0.2 gallons on the fifth instance, Oct. 27, 2007 and a fuel savings of 0.5 gallons could have been realized on Nov. 26, 2007. This information would be entered into the email communication and forwarded to the interested party. This information could be used by the interested party to see that tire pressure maintenance can save fuel. The formula below illustrates how the fuel savings were calculated. These formulas are shown herein by way of example only as one skilled in the art may modify the formula depending on vehicle design or through discoveries made from more testing/modeling.

$$\frac{( Miles\_Driven )}{( 22 \frac{mi}{gal} - ( 2 P S I * \frac{0.4 \%}{P S I} ) * 22 \frac{mi}{gal} )} - \frac{Miles\_Driven}{Average\_Fuel \_Economy}$$

Continuing with the example of Oct. 27, 2007,

$$\frac{436 mi}{21.82 \frac{mi}{gal}} - \frac{436 mi}{22 \frac{mi}{gal}} = 20.0 gallons - 19.8 gallons = 0.2 gallons$$

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A method of providing vehicle information to an interested party regarding the operation of a vehicle, the method comprising:
measuring a parameter of operation produced by the vehicle;
calculating a level based on the parameter measured;
constructing a notification message that includes information concerning the level; and
sending the notification message to the interested party via an electronic messaging system.

2. A method as set forth in claim 1 wherein the step of constructing the notification message includes the step of including a presentation of parameter measured.

3. A method as set forth in claim 2 including the step of correlating the level calculated to savings figure related thereto.

4. A method as set forth in claim 3 wherein the step of constructing the notification message includes generating an email message using markup language.

5. A method as set forth in claim 4 wherein the parameter measured is uploaded to a central data system.

6. A method as set forth in claim 5 including the step of establishing a trigger to identify when the step of measuring is to occur.

7. A method as set forth in claim 6 wherein the step of establishing a trigger includes the step of measuring a time period.

8. A method as set forth in claim 6 wherein the step of establishing a trigger includes the step of measuring a second parameter that is related to the parameter of operation.

9. A method for providing vehicle information to an interested party regarding the performance efficiencies of the motor vehicle operation, the method comprising:
measuring a parameter of operation produced by the vehicle;
calculating a level based on the parameter measured;
constructing a notification message that includes information concerning the level; and
sending the notification message to the interested party via an electronic messaging system.

10. A method as set forth in claim 9 wherein the step of constructing the notification message includes the step of including a presentation of parameter measured.

11. A method as set forth in claim 10 including the step of correlating the level calculated to savings figure related thereto.

12. A method as set forth in claim 11 wherein the step of constructing the notification message includes generating an email message using markup language.

13. A method as set forth in claim 12 wherein the parameter measured is uploaded to a central data system.

14. A method as set forth in claim 13 including the step of establishing a trigger to identify when the step of measuring is to occur.

15. A method as set forth in claim 14 wherein the step of establishing a trigger includes the step of measuring a time period.

16. A method as set forth in claim 15 wherein the step of establishing a trigger includes the step of measuring a second parameter that is related to the parameter of operation.
